(19) United States
(12) Patent Application Publication
(10) Pub. No.: US 2015/0160572 A1
(43) Pub. Date: Jun. 11, 2015

(54) COATING SOLUTION FOR FORMING CHARGE TRANSPORT LAYER, ELECTROPHOTOGRAPHIC PHOTORECEPTOR PREPARED THEREWITH AND IMAGE FORMING APPARATUS COMPRISING THE SAME

(71) Applicant: SHARP KABUSHIKI KAISHA, Osaka (JP)

(72) Inventors: Kotaro FUKUSHIMA, Osaka (JP); Kouki BABA, Osaka (JP); Tomoko KANAZAWA, Osaka (JP); Takahiro KURAUCHI, Osaka (JP)

(21) Appl. No.: 14/542,043

(22) Filed: Nov. 14, 2014

(30) Foreign Application Priority Data
Dec. 9, 2013 (JP) 2013-253784
Dec. 9, 2013 (JP) 2013-253788

(51) Int. Cl. G03G 5/06

(52) U.S. Cl. CPC G03G 5/0614

(57) ABSTRACT

The present invention provides a coating solution for forming a charge transport layer including a charge transport material, a binder resin and tetrafluoroethylene resin fine particles, wherein
the binder resin exhibits a surface free energy of 25 to 35 mJ/mm² in the charge transport layer formed with a coating solution for forming a charge transport layer without comprising the tetrafluoroethylene resin fine particles; and
the tetrafluoroethylene resin fine particles
(1) include primary particles having an average particle diameter of 0.1 to 0.5 μm and secondary particles corresponding to aggregates of the primary particles;
(2) account for 1 to 30% by weight of non-solvent components in the coating solution;
(3) contain primary particles and secondary particles having a particle diameter of less than 1 μm at a content of less than 80% by weight; and
(4) contain secondary particles having a particle diameter of 3 μm or more at a content of no more than 5% by weight.

### CROSS-REFERENCE TO RELATED APPLICATIONS

This application is related to Japanese Patent Application Nos. 2013-253784 and 2013-253788 filed on 9 Dec., 2013, whose priorities are claimed under 35 USC §119, and the disclosures of which are incorporated by reference in their entirety.

### BACKGROUND OF THE INVENTION

1. Field of the Invention

The present invention relates to a coating solution for forming a charge transport layer, an electrophotographic photoreceptor prepared therewith and an image forming apparatus including the electrophotographic photoreceptor. More specifically, the present invention relates to a coating solution for forming a charge transport layer having dispersion stability and containing a binder resin which exhibits a specific value of surface free energy after heating, drying and curing and a specific amount of tetrafluoroethylene resin fine particles having a specific particle diameter, a charge transport layer prepared with the coating solution for forming the charge transport layer, an electrophotographic photoreceptor including a charge generation layer containing a charge generation material having a specific crystal form and an electrophotographic image forming apparatus (also referred to as “image forming apparatus”) including the electrophotographic photoreceptor.

2. Description of the Related Art

In electrophotographic image forming apparatuses that are used as copying machines, printers, facsimile machines and the like, an image is formed through the following electrophotographic process.

First, a photosensitive layer of an electrophotographic photoreceptor (also referred to as “photoreceptor”) in an image forming apparatus is uniformly charged at a predetermined potential by a charger. Subsequently, the photoreceptor is exposed to light (such as laser light) emitted by exposure means according to image information, thereby forming an electrostatic latent image in the photoreceptor. A developer is supplied from developing means to the electrostatic latent image formed, and a component of the developer, that is, colored fine particles referred to as toner is attached to the surface of the photoreceptor. Thus, the electrostatic latent image is developed into a visible toner image. Further, the toner image formed is transferred from the surface of the photoreceptor to a transfer material such as recording paper by transfer means and fixed thereon by fixing means.

However, not all the toner on the surface of the photoreceptor is transferred to the recording paper in the transfer by the transfer means, but some of the toner is left on the surface of the photoreceptor. In addition, some paper particles from the recording paper having been in contact with the photoreceptor in the transfer may adhere to the surface of the photoreceptor and remain thereon. Having an adverse effect on the quality of an image to be formed, such foreign matters as the residual toner and the adhering paper particles on the surface of the photoreceptor are removed by a cleaner.

In recent years, furthermore, there have been technological advances toward a cleaner-less system, and the foreign matters may be removed with a system (so-called developing and cleaning system), in which the residual toner is recovered by a cleaning function added to the developing means without using independent cleaning means. According to this method, charges on the surface of the photosensitive layer are removed by a discharging device after the surface of the photoreceptor is developed, and then the electrostatic latent image is eliminated.

A photoreceptor that is used in such an electrophotographic process has a configuration including a photosensitive layer containing a photoconductive material stacked on a conductive substrate made of a conductive material.

As the photoreceptor, inorganic photoreceptors formed from an inorganic photoconductive material and organic photoreceptors formed from an organic photoconductive material (organic photoconductor, abbreviated as OPC) may be mentioned. Since recent research and development has improved the sensitivity and the durability of organic photoreceptors, the organic photoreceptors are more commonly used today.

Multilayered photoreceptors have been recently mainstream photoreceptors, in which a photosensitive layer includes functionally-separated layers: a charge generation layer containing a charge generation material and a charge transport layer containing a charge transport material. Most of the photoreceptors are negatively chargeable photoreceptors in which a charge transport layer formed from a charge transport material having a charge transport ability molecularly dispersed in a binder resin is stacked on a charge generation layer formed from a charge generation material vapor-deposited or dispersed in a binder resin. In addition, monolayer photoreceptors have been proposed, in which a charge generation material and a charge transport material are uniformly dispersed or dissolved in the same binder resin. Furthermore, in order to improve the quality of an image to be printed, an undercoat layer may be provided between the conductive substrate and the photosensitive layer.

Disadvantages of the above organic photoreceptor include surface wear caused by slide and brush of a cleaner or the like on the periphery of the photoreceptor due to the nature of organic materials. In order to overcome the disadvantage, an attempt has been made so far to improve mechanical properties of the material of the surface of the photoreceptor.

Japanese Unexamined Patent Publication No. HEI 1(1989)-172970 which discloses a method for improving mechanical properties of a material at the surface of a photoreceptor indicates addition of filler particles to a protective layer. It has also been considered to add fluorinated particles (particles of a fluororesin) to the surface as a filler (for example, Japanese Patent No. 3148571).

Having a high lubricating function derived from their material, one of the characteristics of the fluorinated particles as a filler is not only to improve mechanical properties of the photoreceptor but also to reduce the friction between the photoreceptor and a member in contact with the photoreceptor during the process by giving the photoreceptor lubricity, thereby contributing to improvement of the printing durability of the surface of the photoreceptor.

An example of fluorinated particles includes polytetrafluoroethylene or tetrafluoroethylene resin fine particles. Tetrafluoroethylene resin fine particles have an excellent lubricating function as a material. However, the particles do not have polarity, and therefore have a very large particle-to-particle attraction force. The particles are therefore disadvantageous in that they show extremely poor dispersibility. Accordingly, it is necessary to use an auxiliary dispersant when tetrafluoroethylene resin fine particles are dispersed in a surface layer of a photoreceptor (for example, Japanese Patent No. 3186010). As a result, use of the tetrafluoroethylene resin fine particles deteriorates electric properties of the photoreceptor. When a commodity resin for a photoreceptor such as a polycarbonate resin is used to disperse tetrafluoroethylene resin fine particles, aggregates of 1 μm or less are temporarily predominant, and thus dispersion may be promoted (Japanese Unexamined Patent Publication No. 2005-43765). However, the dispersion is not stable over time. Moreover, addition of tetrafluoroethylene resin particles may also deteriorate electric stability.

On the other hand, because the properties of multilayered photoreceptors are affected by charge generation efficiency of a charge generation material or charge injection efficiency to a charge transport layer during preparation of the photoreceptors, various crystal forms have been proposed (for example, Japanese Examined Patent Publication No. HEI 6(1994)-29975).

### SUMMARY OF THE INVENTION

When a photoreceptor is prepared which includes a surface layer containing fluorinated fine particles by adding a normal polycarbonate resin without having an effect on reduction of the surface free energy to an outermost surface layer of the photoreceptor containing tetrafluoroethylene fine particles, a preferable initial sensitivity or preferable electric properties during repetitive use may not be obtained and the electric properties of the photoreceptor may be deteriorated during repetitive use.

In addition, when a normal polycarbonate resin is used, it is difficult to obtain a coating solution having sufficient dispersion stability over time.

Thus an object of the present invention is to provide an electrophotographic photoreceptor which maintains preferable wear resistance and realizes both preferable dispersibility and preferable electric properties of a photoreceptor-containing component.

The inventors of the present invention have made intensive studies to achieve the above-described object and, as a result, found that a coating solution for formation of an outermost surface layer of a photoreceptor has excellent dispersion stability over a long period of time by including a binder resin exhibiting a specific value of the surface free energy after curing and a specific amount of tetrafluoroethylene resin fine particles having a specific particle diameter, and that it is possible to provide an electrophotographic photoreceptor which is prepared with the coating solution and maintains wear resistance while having preferable electric properties, dispersibility and dispersion stability by including, during preparation of the electrophotographic photoreceptor including an outermost surface layer, that is, a photosensitive layer, a charge transport layer or a protective layer covering the photosensitive layer, a binder resin exhibiting a specific value of the surface free energy after heating and drying, and a specific amount of tetrafluoroethylene resin fine particles having a specific particle diameter in the outermost surface layer and using an oxotitanylphthalocyanine having a specific crystal form as a charge generation material. Thus, the inventors have completed the present invention.

According to an aspect of the present invention, there is provided a coating solution for forming a charge transport layer including a charge transport material, a binder resin and tetrafluoroethylene resin fine particles, wherein

the binder resin exhibits a surface free energy of 25 to 35 mJ/mm² in a charge transport layer formed with a coating solution for forming a charge transport layer without comprising the tetrafluoroethylene resin fine particles; and

the tetrafluoroethylene resin fine particles

(1) include primary particles having an average particle diameter of 0.1 to 0.5 μm and secondary particles corresponding to aggregates of the primary particles;

(2) account for 1 to 30% by weight of non-solvent components in the coating solution;

(3) contain primary particles and secondary particles having a particle diameter of less than 1 μm at a content of less than 80% by weight; and

(4) contain secondary particles having a particle diameter of 3 μm or more at a content of no more than 5% by weight.

According to an aspect of the present invention, there is also provided the coating solution for forming the charge transport layer, wherein the tetrafluoroethylene resin fine particles contain primary particles having an average particle diameter of 0.2 to 0.4 μm.

According to an aspect of the present invention, there is also provided the coating solution for forming the charge transport layer, wherein the tetrafluoroethylene resin fine particles account for 5 to 15% by weight of the non-solvent components in the coating solution.

According to an aspect of the present invention, there is also provided the coating solution for forming the charge transport layer, wherein the tetrafluoroethylene resin fine particles account for 8 to 12% by weight of the non-solvent components in the coating solution.

According to an aspect of the present invention, there is also provided the coating solution for forming the charge transport layer, wherein the surface free energy is in the range of 27 to 32 mJ/mm².

According to another aspect of the present invention, there is provided a multilayered electrophotographic photoreceptor having a charge generation layer containing at least a charge generation material and a charge transport layer containing a charge transport material stacked in this order on a conductive substrate, or a monolayer electrophotographic photoreceptor having a photosensitive layer containing a charge generation material and a charge transport material stacked on a conductive substrate, wherein an outermost surface layer of the photoreceptor contains at least the charge transport material, a binder resin and tetrafluoroethylene resin fine particles,

the binder resin exhibits a surface free energy of 25 to 35 mJ/mm² in a charge transport layer formed with a coating solution for forming a charge transport layer without comprising the tetrafluoroethylene resin fine particles; and

the tetrafluoroethylene resin fine particles

(1) include primary particles having an average particle diameter of 0.1 to 0.5 μm and secondary particles corresponding to aggregates of the primary particles;

(2) account for 1 to 30% by weight of the outermost surface layer;

(3) contain primary particles and secondary particles having a particle diameter of less than 1 μm at a content of less than 80% by weight; and

(4) contain secondary particles having a particle diameter of 3 μm or more at a content of no more than 5% by weight.

According to an aspect of the present invention, there is also provided the electrophotographic photoreceptor, wherein the outermost surface layer is formed with the coating solution for forming the charge transport layer of the present invention.

According to an aspect of the present invention, there is provided the electrophotographic photoreceptor, wherein the charge generation material is a titanyl phthalocyanine having a crystal form showing, in an X-ray diffraction spectrum, a maximum diffraction peak at a Bragg angle (2θ±0.2°) of 27.3° and diffraction peaks at 7.3°, 9.4°, 9.7° and 27.3° or first and second intense peaks at 9.4° and 9.7° and diffraction peaks at least at 7.3°, 9.4°, 9.7° and 27.3°.

According to an aspect of the present invention, there is provided the electrophotographic photoreceptor, wherein the tetrafluoroethylene resin fine particles include primary particles having an average particle diameter of 0.2 to 0.4 μm.

According to an aspect of the present invention, there is provided the electrophotographic photoreceptor, wherein the tetrafluoroethylene resin fine particles account for 5 to 15% by weight of the outermost surface layer.

According to an aspect of the present invention, there is provided the electrophotographic photoreceptor, wherein the tetrafluoroethylene resin fine particles account for 8 to 12% by weight of the outermost surface layer.

According to an aspect of the present invention, there is provided the electrophotographic photoreceptor, wherein the surface free energy is in the range of 27 to 32 mJ/mm².

According to an aspect of the present invention, there is provided the electrophotographic photoreceptor, including the multilayered photosensitive layer stacked on the conductive substrate via an undercoat layer.

According to an aspect of the present invention, there is provided the electrophotographic photoreceptor, wherein the multilayered photosensitive layer includes two charge transport layers containing the charge transport material at different concentrations and the charge transport layer at the outermost surface layer contains the tetrafluoroethylene resin fine particles.

According to another aspect of the present invention, there is further provided an image forming apparatus including: the electrophotographic photoreceptor; charge means for charging the electrophotographic photoreceptor; exposure means for exposing the charged electrophotographic photoreceptor to form an electrostatic latent image; developing means for developing the electrostatic latent image with toner to form a toner image; transfer means for transferring the toner image onto a recording material; and fixing means for fixing the transferred toner image on the recording material.

The present invention can provide a coating solution which allows preparation of an electrophotographic photoreceptor having preferable electric properties and dispersibility and has dispersion stability over a long period of time; an electrophotographic photoreceptor prepared with the coating solution, having excellent wear resistance and having both preferable dispersibility and preferable electric properties; and an image forming apparatus including the electrophotographic photoreceptor.

### BRIEF DESCRIPTION OF THE DRAWINGS

FIG. 1 is a schematic view (sectional view) showing a configuration of an electrophotographic photoreceptor according to Embodiment 1 of the present invention;

FIG. 2 is a schematic view (sectional view) showing a configuration of an electrophotographic photoreceptor according to Embodiment 2 of the present invention;

FIG. 3 is a schematic view (sectional view) showing a configuration of an electrophotographic photoreceptor according to Embodiment 3 of the present invention; and

FIG. 4 is a schematic view (side sectional view) showing a configuration of an image forming apparatus according to Embodiment 4 of the present invention.

### DESCRIPTION OF THE PREFERRED EMBODIMENTS

A coating solution for forming a charge transport layer of the present invention contains at least a specific binder resin and a specific amount of tetrafluoroethylene resin fine particles having a specific particle diameter and has preferable dispersibility over a long period of time.

An electrophotographic photoreceptor (hereinafter also merely referred to as “photoreceptor”) of the present invention contains at least a specific binder resin and a specific amount of fluorinated resin fine particles, preferably tetrafluoroethylene resin fine particles, having a specific particle diameter, has preferable dispersibility and includes a charge generation layer containing a charge generation material having a specific crystal form.

An electrophotographic photoreceptor of the present invention may include a multilayered photosensitive layer having a charge generation layer containing a charge generation material and a charge transport layer containing a charge transport material stacked in this order on a conductive substrate, or a monolayer photosensitive layer having a photosensitive layer containing a charge generation material and a charge transport material formed on the conductive substrate.

Therefore one of the characteristics of the coating solution for forming the charge transport layer of the present invention is that it can be used as it is when a multilayered photosensitive layer is prepared and alternatively it can be used with a charge generation material added thereto when a monolayer photosensitive layer is prepared.

The electrophotographic photoreceptor may include a protective layer as an outermost surface layer and in this case the protective layer preferably contains the tetrafluoroethylene resin fine particles.

The electrophotographic photoreceptor can be more electrically stabilized with the use of an undercoat layer.

An image forming apparatus (electrophotographic image forming apparatus) of the present invention includes the electrophotographic photoreceptor; charge means for charging the electrophotographic photoreceptor; exposure means for exposing the charged electrophotographic photoreceptor to form an electrostatic latent image; developing means for developing the electrostatic latent image with toner to form a toner image; transfer means for transferring the toner image onto a recording material; and fixing means for fixing the transferred toner image on the recording material. The image forming apparatus may further include cleaning means for removing and recovering toner left on the electrophotographic photoreceptor and discharge means for removing charges remaining on the surface of the electrophotographic photoreceptor. An image forming apparatus of the present invention may have a configuration including the above-described electrophotographic photoreceptor, charge means, exposure means, developing means and transfer means.

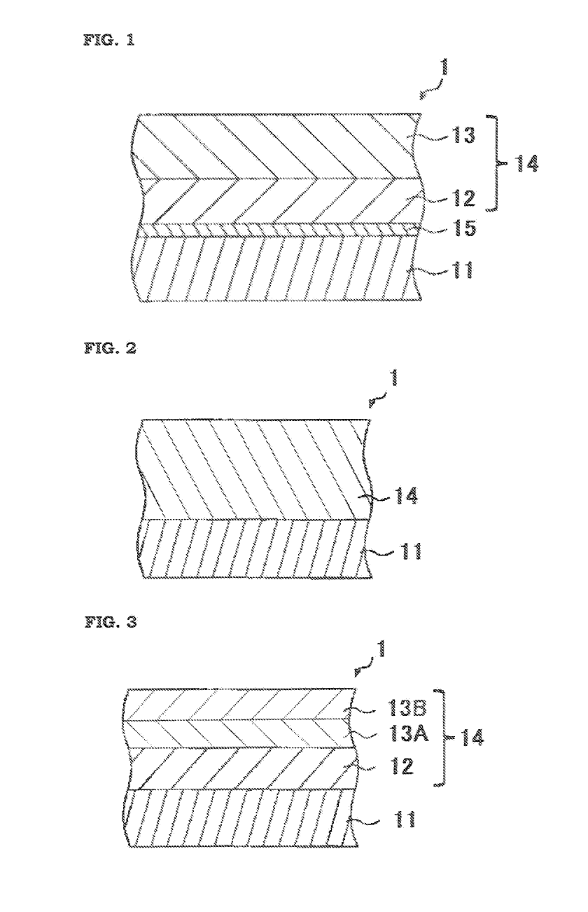

Hereinafter, embodiments and examples of the present invention will be described in detail with reference to FIGS. 1 to 4. It should be noted that the following embodiments and examples are merely concrete examples of the present invention and the present invention is not limited thereto.

### Embodiment 1

FIG. 1 is a schematic view (sectional view) showing a configuration of an electrophotographic photoreceptor according to the present Embodiment. An electrophotographic photoreceptor 1 according to the present Embodiment has a cylindrical conductive substrate 11 formed of a conductive material, an undercoat layer (interlayer) 15 formed on an outer circumferential surface of the conductive substrate 11 and a photosensitive layer 14 formed on an outer circumferential surface of the undercoat layer 15.

The photosensitive layer 14 has, as shown in FIG. 1, a charge generation layer 12 and a charge transport layer 13. The charge generation layer 12 is stacked on an outer circumferential surface of the undercoat layer 15 and contains a charge generation material. The charge transport layer 13 is stacked on an outer circumferential surface of the charge generation layer 12 and contains a charge transport material.

In the example shown in FIG. 1, the charge transport layer 13 among the layers in the photosensitive layer 14 corresponds to a surface layer of the photoreceptor 1.

### Conductive Substrate 11

The conductive substrate 11 plays a role as an electrode of the photoreceptor 1 and functions as a supporting member for the layers disposed thereon (that is, the undercoat layer 15 and the photosensitive layer 14).

While the conductive substrate 11 has a cylindrical shape in the present Embodiment, the shape thereof is not limited to cylindrical and may be columnar, sheet-like or endless-belt-like.

Examples of the conductive material usable for forming the conductive substrate 11 include conductive metals such as aluminum, copper, brass, zinc, nickel, stainless steel, chromium, molybdenum, vanadium, indium, titanium, gold and platinum; alloy materials of the conductive metals; or metal oxides of the conductive metals such as tin oxide and indium oxide.

The conductive material may also be materials obtained by laminating or vapor-depositing foil of the above-mentioned conductive metals on a surface of a polymeric material (such as polyethylene terephthalate, nylon, polyester, polyoxymethylene and polystyrene), hard paper, glass or the like.

The conductive material may also be materials obtained by vapor-depositing or applying a layer of a conductive compound such as a conductive polymer, tin oxide, indium oxide or the like on a surface of the polymeric material, hard paper, glass or the like. These conductive materials are processed into a predetermined shape to form the conductive substrate 11.

It is preferable that a surface of the conductive substrate 11 is processed by, if necessary, anodic oxidation coating treatment, surface treatment using chemicals or hot water, coloring treatment or irregular reflection treatment such as surface roughing to the extent that the image quality is not adversely affected.

Since laser light has a uniform wavelength in an electrophotographic process with the use of a laser as an exposure light source, laser light reflected on the surface of the photoreceptor may interfere with the laser light reflected on the inside of the photoreceptor, resulting in appearance of interference fringes on an image and generation of an image defect. However, such an image defect due to the interference by the laser light having a uniform wavelength can be prevented by giving the surface of the conductive substrate 11 the above-mentioned treatments.

### Undercoat Layer (Interlayer) 15

Without the undercoat layer 15 between the conductive substrate 11 and the photosensitive layer 14, a defect in the conductive substrate 11 or the photosensitive layer 14 may reduce the chargeability in micro areas, and thus image fogging such as black dots may be generated, leading to a significant image defect.

To the contrary, with the undercoat layer 15, it is possible to prevent charge injection from the conductive substrate 11 to the photosensitive layer 14. With the undercoat layer 15, therefore, reduction in the chargeability of the photosensitive layer 14 can be prevented, and reduction in surface charges in areas other than those where surface charges should be eliminated by light exposure can be suppressed, preventing generation of a defect such as image fogging.

With the undercoat layer 15, furthermore, unevenness in the surface of the conductive substrate 11 can be covered to give an even surface. Accordingly, the film formation for the photosensitive layer 14 is facilitated, separation of the photosensitive layer 14 from the conductive substrate 11 can be inhibited, and the adhesion between the conductive substrate 11 and the photosensitive layer 14 can be improved.

A resin layer of a variety of resin materials or an alumite layer may be used for the undercoat layer 15. Examples of the resin materials for forming the resin layer include resins such as polyethylene resins, polypropylene resins, polystyrene resins, acrylic resins, polyvinyl chloride resins, polyvinyl acetate resins, polyurethane resins, epoxy resins, polyester resins, melamine resins, silicone resins, polyvinyl butyral resins, polyvinyl pyrrolidone resins, polyacrylamide resins and polyamide resins; and copolymer resins including two or more of the repeat units that form the above-mentioned resins. In addition, may be mentioned casein, gelatin, polyvinyl alcohol, cellulose, nitrocellulose and ethyl cellulose.

Of these resins, polyamide resins are preferably used, and alcohol-soluble nylon resins are particularly preferably used.

Examples of the preferable alcohol-soluble nylon resins include so-called nylons such as 6-nylon, 6,6-nylon, 6,10-nylon, 11-nylon, 2-nylon and 12-nylon; and resins obtained by chemically modifying nylon such as N-alkoxymethyl-modified nylon and N-alkoxyethyl-modified nylon.

In order to give the undercoat layer 15 a charge controlling function, a filler is added to the undercoat layer 15. The filler added to the undercoat layer 15 which may be used is metal oxide fine particles. Examples thereof include particles of titanium oxide, aluminum oxide, aluminum hydroxide and tin oxide. The metal oxide appropriately has a particle diameter of 0.01 to 0.3 μm. Preferably, the particle diameter is 0.02 to 0.1 μm.

The undercoat layer 15 can be formed, for example, by dissolving or dispersing the above-mentioned resin in an appropriate solvent to prepare a coating solution for undercoat layer formation and applying the coating solution onto the surface of the conductive substrate 11. For forming the undercoat layer 15 containing the oxide fine particles or the like, for example, the metal oxide fine particles are dispersed in the resin solution obtained by dissolving the resin in an appropriate solvent to prepare a coating solution for undercoat layer formation and the coating solution is applied onto the surface of the conductive substrate 11 to obtain the undercoat layer 15.

Water, various organic solvents, and mixture thereof may be used as the solvent for the coating solution for undercoat layer formation. For example, a single solvent of water, methanol, ethanol or butanol; or a mixed solvent of water and an alcohol, a mixed solvent of two or more kinds of alcohols, a mixed solvent of acetone or dioxolane and an alcohol, a mixed solvent of a halogen-based organic solvent such as dichloroethane, chloroform or trichloroethane and an alcohol may be used. Of these solvents, non-halogen organic solvents are preferably used in terms of global environmental consideration.

The metal oxide fine particles can be dispersed in the resin solution (coating solution for undercoat layer formation) by any common method such as those with the use of a ball mill, a sand mill, an attritor, an oscillation mill, an ultrasonic disperser or a paint shaker. A more stable coating solution can be prepared by using a media-less disperser that uses a very strong shear force to be generated by passing the fluid dispersion through micro voids under ultra high pressure.

Examples of the method of applying the coating solution for undercoat layer formation include a spraying method, a bar coating method, a roll coating method, a blade method, a ring method and a dip coating method. Of the coating methods, in particular, the dip coating method is relatively simple and advantageous in terms of productivity and costs, and therefore often used for the production of undercoat layers 15.

The undercoat layer 15 has a film thickness of preferably 0.01 μm to 20 μm, and more preferably 0.05 μm to 10 μm.

When the undercoat layer 15 has a film thickness of less than 0.01 μm, the resulting layer does not substantially function as the undercoat layer 15 as failing to cover unevenness in the conductive substrate 11 to give an even surface and failing to prevent charge injection from the conductive substrate 11 to the photosensitive layer 14, and thus the chargeability of the photosensitive layer 14 is reduced. It is not preferable either that the undercoat layer 15 has a film thickness of more than 20 μm, because in this case, it is difficult to form the undercoat layer 15 by the dip coating method and it is impossible to uniformly form the photosensitive layer 14 on the undercoat layer 15, and thus the sensitivity of the photoreceptor is reduced. Accordingly, the suitable range of the film thickness of the undercoat layer 15 is 0.01 to 20 μm.

### Charge Generation Layer 12

The charge generation layer 12 contains, as a main component, a charge generation material that absorbs light to generate charges.

Examples of the material useful as the charge generation material include organic photoconductive materials including organic pigments and inorganic photoconductive materials including inorganic pigments.

Examples of the organic photoconductive materials include azo pigments such as monoazo pigments, bisazo pigments and trisazo pigments; indigoid pigments such as indigo and thioindigo; perylene pigments such as perylenimide and perylenic anhydride; polycyclic quinone pigments such as anthraquinone and pyrenequinone; phthalocyanine pigments such as metal phthalocyanines and metal-free phthalocyanines; squarylium dyes; pyrylium and thiopyrylium salts; and triphenylmethane dyes.

Examples of the inorganic photoconductive materials include selenium and alloys thereof, arsenic-selenium, cadmium sulfide, zinc oxide, amorphous silicon and other inorganic photoconductors.

The charge generation material in the present invention is preferably titanyl phthalocyanine. The charge generation material is particularly preferably a titanyl phthalocyanine having a crystal form showing, in an X-ray diffraction spectrum, first and second intense peaks at a Bragg angle (2θ±0.2°) of 9.4° and 9.7° and diffraction peaks at least at 7.3°, 9.4°, 9.7° and 27.3°, in terms of the effect exhibited thereby in combination with other components in the present invention.

The charge generation material may be used in combination with a sensitizing dye including triphenylmethane type dyes such as Methyl Violet, Crystal Violet, Night Blue and Victoria Blue; acridine dyes such as Erythrocin, Rhodamine B, Rhodamine 3R, Acridine Orange and Flapeocine; thiazine dyes such as Methylene Blue and Methylene Green; oxazine dyes such as Capri Blue and Meldola's Blue; cyanine dyes; styryl dyes; pyrylium salt dyes; and thiopyrylium salt dyes.

Examples of the method of forming the charge generation layer 12 include a method by vacuum deposition of the charge generation material on the surface of the conductive substrate 11 and a method by applying, to the surface of the conductive substrate 11, the coating solution for charge generation layer formation obtained by dispersing the charge generation material in an appropriate solvent.

Particularly, a method is suitably used in which a coating solution for charge generation layer formation is prepared by dispersing the charge generation material in a binder resin solution obtained by dissolving a binder resin as a binding agent in a solvent by a conventionally known method, and the resulting coating solution (application solution) is applied to the surface of the conductive substrate 11. Hereinafter, this method will be described.

Examples of the binder resin to be used for the charge generation layer 12 include resins such as polyester resins, polystyrene resins, polyurethane resins, phenol resins, alkyd resins, melamine resins, epoxy resins, silicone resins, acrylic resins, methacrylic resins, polycarbonate resins, polyarylate resins, phenoxy resins, polyvinyl butyral resins, polyvinyl chloride resins and polyvinyl formal resins; and copolymer resins including at least two of the repeat units that form the above-mentioned resins.

Specific examples of the copolymer resins include insulating resins such as vinyl chloride-vinyl acetate copolymer resins, vinyl chloride-vinyl acetate-maleic anhydride copolymer resins and acrylonitrile-styrene copolymer resins.

The binder resin is not limited to the above-mentioned resins, and any commonly used resin may be used as the binder resin. These resins may be used independently, or two or more kinds may be used in combination.

Examples of the solvent that may be used for the coating solution for charge generation layer formation include halogenated hydrocarbons such as dichloromethane and dichloroethane; alcohols such as methanol and ethanol; ketones such as acetone, methyl ethyl ketone and cyclohexanone; esters such as ethyl acetate and butyl acetate; ethers such as tetrahydrofuran and dioxane; alkyl ethers of ethylene glycol such as 1,2-dimethoxyethane; aromatic hydrocarbons such as benzene, toluene and xylene; and aprotic polar solvents such as N,N-dimethylformamide and N,N-dimethylacetamide.

Of these solvents, non-halogen organic solvents are preferably used in terms of global environmental consideration. The above-mentioned solvents may be used independently, or two or more kinds may be used in combination.

In the charge generation layer 12 including the charge generation material and the binder resin, the ratio W1/W2 between the weight W1 of the charge generation material and the weight W2 of the binder resin is preferably 10/100 to 400/100.

If the ratio W1/W2 is lower than 10/100, the sensitivity of the photoreceptor 1 may be reduced.

If the ratio W1/W2 is higher than 400/100, on the other hand, not only is the film strength of the charge generation layer 12 reduced but the dispersibility of the charge generation material is also reduced, increasing coarse particles. As a result, surface charges in areas other than those where surface charges should be eliminated by light exposure are reduced, and an image defect, in particular, image fogging called black dots formed as small black spots made of a toner on a white background area increases.

Accordingly, the suitable range of the ratio W1/W2 is 10/100 to 400/100.

The charge generation material may be preliminarily milled with a milling machine before being dispersed in the binder resin solution.

Examples of the milling machine to be used for the milling include a ball mill, a sand mill, an attritor, an oscillation mill and an ultrasonic dispersing machine.

Examples of the dispersing machine to be used for dispersing the charge generation material in the binder resin solution include a paint shaker, a ball mill and a sand mill. On this occasion, it is preferable that dispersion conditions are set as appropriate so as to prevent contamination of the solution with impurities generated due to abrasion or the like of members forming the container and the dispersing machine to use.

Examples of the method of applying the coating solution for charge generation layer formation include a spraying method, a bar coating method, a roll coating method, a blade method, a ring method and a dip coating method. An optimal method can be selected from the above-mentioned coating methods in consideration of the physical properties of the coating solution and the productivity.

Of the coating methods, in particular, the dip coating method is relatively simple and advantageous in terms of productivity and costs, and therefore often used for the production of photoreceptors. In the dip coating method, the substrate is dipped in a coating vessel filled with the coating solution, and then raised at a constant rate or at a rate that changes successively to form a layer on the surface of the substrate.

The apparatus to be used for the dip coating method may be provided with a coating solution dispersing machine typified by ultrasonic generators in order to stabilize the dispersibility of the coating solution.

The charge generation layer 12 has a film thickness of preferably 0.05 μm to 5 μm, and more preferably 0.1 μm to 1 μm.

If the charge generation layer 12 has a film thickness of less than 0.05 μm, the efficiency of light absorption is reduced, and the sensitivity of the photoreceptor 1 may be reduced.

If the charge generation layer 12 has a film thickness of more than 5 μm, on the other hand, charge transport may be caused within the charge generation layer 12 to be a rate-determining step in a process of eliminating surface charges of the photosensitive layer 14, reducing the sensitivity of the photoreceptor 1.

Accordingly, the suitable range of the film thickness of the charge generation layer 12 is 0.05 μm to 5 μm.

### Charge Transport Layer 13

The charge transport layer 13 is provided on an outer circumferential surface of the charge generation layer 12. The charge transport layer 13 contains a charge transport material that receives and transports charges generated by the charge generation material included in the charge generation layer 12, and a binder resin that binds the charge transport material.

Filler particles may also be added to the charge transport layer 13 in order to improve wear resistance or the like.

In addition, a variety of additives such as an antioxidant, a sensitizer, a plasticizer or a leveling agent may be added to the charge transport layer 13 as needed.

In addition, a variety of additives may be added to the charge transport layer 13 as needed. Specifically, a plasticizer and a leveling agent may be added to the charge transport layer 13 in order to improve the film formation ability, the flexibility and the surface smoothness. Examples of the plasticizer include dibasic acid esters such as phthalate esters, fatty acid esters, phosphoric esters, chlorinated paraffins and epoxy type plasticizers. Examples of the leveling agent include silicone-based leveling agents.

Examples of the charge transport material include enamine derivatives, carbazole derivatives, oxazole derivatives, oxadiazole derivatives, thiazole derivatives, thiadiazole derivatives, triazole derivatives, imidazole derivatives, imidazolone derivatives, imidazolidine derivatives, bisimidazolidine derivatives, styryl compounds, hydrazone compounds, polycyclic aromatic compounds, indole derivatives, pyrazoline derivatives, oxazolone derivatives, benzimidazole derivatives, quinazoline derivatives, benzofuran derivatives, acridine derivatives, phenazine derivatives, aminostilbene derivatives, triarylamine derivatives, triarylmethane derivatives, phenylenediamine derivatives, stilbene derivatives and benzidine derivatives.

As the binder resin forming the charge transport layer 13, a polycarbonate resin containing a polycarbonate commonly known in the art as a main component is suitably selected since it has higher transparency and printing durability.

The resin may further contain a second component binder resin other than the polycarbonate resin. Examples of the second component include polymethyl methacrylate resins, polystyrene resins and vinyl polymer resins such as polyvinyl chloride resins, and copolymers including two or more of the repeat units that form the above-mentioned resins; and polyester resins, polyester carbonate resins, polysulfone resins, phenoxy resins, epoxy resins, silicone resins, polyarylate resins, polyamide resins, polyether resins, polyurethane resins, polyacrylamide resins and phenolic resins or copolymer resins having a polycarbonate skeleton and a polydimethylsiloxane skeleton.

Thermosetting resins that are obtained by partially cross-linking the above-mentioned resins may also be used.

These resins may be used independently, or two or more kinds may be used in combination.

The phrase “containing a polycarbonate resin . . . as a main component” means that the percentage by weight of the polycarbonate resin accounts for the greatest proportion, preferably, 50 to 90% by weight, of the binder resin as a whole forming the charge transport layer.

The term “second component binder resin” means the binder resin which may be used at a percentage lower than the amount of the polycarbonate resin, that is, 10 to 50% by weight, relative to the total weight of the binder resin in the charge transport layer 13.

Preferably, the weight ratio between the charge transport material and the binder resin in the charge transport layer is 10/18 to 10/10.

The filler particles are roughly classified into organic filler particles and inorganic filler particles including metal oxides. The filler particles need to meet the requirements described below; that is, use of filler particles having a significantly larger relative dielectric constant such as ∈r>10 in the charge transport layer 13 than an average relative dielectric constant (∈r≈3) of the organic photoreceptor can result in nonuniform dielectric constant throughout the charge transport layer 13 and have a negative effect on the electric properties of the charge transport layer 13. Accordingly, the charge transport layer 13 is required to have a relatively small relative dielectric constant.

Taking the above into consideration, organic filler particles are more advantageous than metal oxides.

Further of organic filler particles, fluorinated fine particles (fluorinated resin fine particles) have excellent lubricity.

Thus the present invention is characterized in that fluorinated particles which are tetrafluoroethylene resin (polytetrafluoroethylene: PTFE) fine particles are used as filler particles added to the charge transport layer 13.

The tetrafluoroethylene resin fine particles:

(1) include primary particles having an average particle diameter of 0.1 to 0.5 μm and secondary particles corresponding to aggregates of primary particles;

(2) account for 1 to 30% by weight of the charge transport layer;

(3) contain primary particles and secondary particles having a particle diameter of less than 1 μm at a content of less than 80% by weight; and

(4) contain secondary particles having a particle diameter of 3 μm or more at a content of no more than 5% by weight.

The tetrafluoroethylene resin fine particles added to the charge transport layer preferably have a low particle diameter in order to decrease as much as possible an adverse effect to light scattering and electrical carriers in the charge transport layer 13. Therefore in the present invention tetrafluoroethylene resin fine particles having an average primary particle diameter of 0.1 to 0.5 μm and more preferably 0.2 to 0.4 μm are suitably used.

If the tetrafluoroethylene resin fine particles have an average primary particle diameter of less than 0.1 μm, the primary particles are significantly aggregated to increase light scattering.

If the tetrafluoroethylene resin fine particles have an average primary particle diameter of higher than 0.5 μm, an increase in light scattering by primary particles is caused thereby.

Therefore the tetrafluoroethylene resin fine particles have an average primary particle diameter in an adequate range of 0.1 to 0.5 μm.

The tetrafluoroethylene resin fine particles preferably account for 1 to 30% by weight of the charge transport layer.

The charge transport layer containing 1 to 30% by weight and more preferably 5 to 15% by weight of the tetrafluoroethylene resin particles can provide a photoreceptor having both excellent printing durability and stable electric properties.

If the amount of the tetrafluoroethylene resin fine particles in the charge transport layer is less than 1% by weight, an improvement in wear resistance of the photoreceptor is not obtained by addition of the tetrafluoroethylene resin fine particles.

If the amount of the tetrafluoroethylene resin fine particles in the charge transport layer is higher than 30% by weight, the electric properties of the photoreceptor are significantly deteriorated and the photoreceptor may not tolerate in practical use.

As in the case of the oxide fine particles to be added to the undercoat layer, the filler particles, which are tetrafluoroethylene resin particles, can be dispersed by a common method such as those with the use of a ball mill, a sand mill, an attritor, an oscillation mill, an ultrasonic disperser and a paint shaker. A more stable coating solution can be prepared by using a media-less disperser that uses a very strong shear force to be generated by passing the fluid dispersion through micro voids under ultra high pressure.

As in the case of the formation of the charge generation layer 12 by a coating method, the charge transport layer 13 is formed by dissolving or dispersing the charge transport material, the binder resin, the filler particles and/or the additives in an appropriate solvent to prepare a coating solution for forming the charge transport layer, and applying the resulting coating solution (application solution) on an outer circumferential surface of the charge generation layer 12, for example.

Examples of the solvent of the coating solution for forming the charge transport layer include aromatic hydrocarbons such as benzene, toluene, xylene and monochlorobenzene; halogenated hydrocarbons such as dichloromethane and dichloroethane; ethers such as tetrahydrofuran, dioxane and dimethoxymethyl ether; and aprotic polar solvents such as N,N-dimethylformamide. These solvents may be used independently, or two or more kinds may be used in combination.

As needed, a solvent such as an alcohol, acetonitrile and methyl ethyl ketone may be further added to the solvent. Of these solvents, non-halogen organic solvents are preferably used in terms of global environmental consideration.

Examples of the method of applying the coating solution for forming the charge transport layer include a spraying method, a bar coating method, a roll coating method, a blade method, a ring method and a dip coating method. Of these coating methods, in particular, the dip coating method is usable also for the formation of the charge transport layer 13, because it is advantageous in various points as described above.

The charge transport layer 13 has a film thickness of preferably 5 μm to 40 μm, and more preferably 10 μm to 30 μm.

It is not preferable that the charge transport layer 13 has a film thickness of less than 5 μm, because in this case, the charge retention ability thereof is reduced.

It is not preferable that the charge transport layer 13 has a film thickness of more than 40 μm, because in this case, the resolution of the photoreceptor 1 is reduced.

Accordingly, the suitable range of the film thickness of the charge transport layer 13 is 5 μm to 40 μm.

### Additives to Photosensitive Layer 14

In order to improve the sensitivity and inhibit an increase in residual potential and fatigue due to repeated use, one or more kinds of sensitizers such as electron acceptor substances and dyes may be added to each layer (charge generation layer 12 or charge transport layer 13) of the photosensitive layer 14.

Examples of the electron acceptor substances include electron attractive materials such as acid anhydrides including succinic anhydride, maleic anhydride, phthalic anhydride and 4-chloronaphthalic acid anhydride; cyano compounds including tetracyanoethylene and terephthalmalondinitrile; aldehydes including 4-nitrobenzaldehyde; anthraquinones including anthraquinone and 1-nitroanthraquinone; polycyclic or heterocyclic nitro compounds including 2,4,7-trinitrofluorenone and 2,4,5,7-tetranitrofluorenone; and diphenoquinone compounds. In addition, materials obtained by polymerizing these electron attractive materials may be used.

Examples of the dyes include organic photoconductive compounds such as xanthene-based dyes, thiazine dyes, triphenylmethane dyes, quinoline-based pigments and copper phthalocyanine. These organic photoconductive compounds function as an optical sensitizer.

Furthermore, an antioxidant or an ultraviolet absorber may be added to each of the layers of the photosensitive layer 14. In particular, it is preferable to add an antioxidant, an ultraviolet absorber or the like to the charge transport layer 13. The addition of an antioxidant or an ultraviolet absorber may enhance the stability of the coating solution for forming each layer by a coating method.

Addition of an antioxidant to the charge transport layer 13 can reduce deterioration of the photosensitive layer due to oxidized gases such as ozone and nitrogen oxides. Examples of the antioxidant include phenol compounds, hydroquinone compounds, tocopherol compounds and amine compounds. Of these antioxidants, hindered phenol derivatives or hindered amine derivatives or mixtures thereof are suitably used.

### Embodiment 2

Embodiment 1 has been described in which the photosensitive layer 14 includes the charge generation layer 12 and the charge transport layer 13. In another embodiment, however, the photosensitive layer 14 may be a single layer as a photoreceptor 1 shown in FIG. 2. Specifically, the photoreceptor 1 may be formed from the cylindrical conductive substrate 11 made of a conductive material and a photosensitive layer 14 which is a layer stacked on an outer circumferential surface of the conductive substrate 11 and which contains a charge generation material and a charge transport material. In this case, a coating solution for monolayer photosensitive layer formation can be obtained by adding a charge generation material to the coating solution for forming the charge transport layer of the present invention.

In FIG. 2, the whole photosensitive layer 14 corresponds to the surface layer of the photoreceptor 1 and the tetrafluoroethylene resin fine particles are added to the photosensitive layer 14.

### Embodiment 3

In another embodiment, the charge transport layer may be formed from a plurality of layers as shown in FIG. 3. A photoreceptor 1 in FIG. 3 includes the conductive substrate 11 and a photosensitive layer 14 formed on an outer circumferential surface of the conductive substrate 11. The photosensitive layer 14 includes a charge generation layer 12 formed on an outer circumferential surface of the conductive substrate 11; a first charge transport layer 13A formed on an outer circumferential surface of the charge generation layer 12; and a second charge transport layer 13B formed on an outer circumferential surface of the first charge transport layer 13A. In the photoreceptor 1 shown in FIG. 3, the first charge transport layer 13A and the second charge transport layer 13B are formed so as to include different amounts of a charge transport material. In the configuration shown in FIG. 3, the second charge transport layer 13B in the photosensitive layer 14 corresponds to an outermost surface layer and the tetrafluoroethylene resin fine particles are added to the second charge transport layer 13B.

An embodiment of the present invention may also be applied to a photoreceptor including a protective layer which is formed on an outer circumferential surface of the photosensitive layer and which corresponds to a surface layer. In the embodiment, it is preferable that the tetrafluoroethylene resin fine particles are added to a binder resin in the protective layer.

### Surface Free Energy of Photoreceptor

The surface wettability of a photoreceptor is often expressed as the surface free energy (γ). In order to decrease the wettability or in other words to improve the repellency of a surface, a material having low surface free energy is used. A typical example of the material is tetrafluoroethylene resin fine particles which are widely used. The γ value of a surface of a photosensitive layer can be decreased by adding a component having low surface free energy to a binder resin used for a surface (mostly a charge transport layer) of a photoreceptor.

For example, a copolymer having a repeat structure having a siloxane skeleton may be used as a binder resin. A binder resin which is a copolymer having an ethylene fluoride skeleton may also be used.

By changing the formulation ratio of the copolymers, the surface free energy of the surface of a photosensitive layer formed can be adjusted.

### Embodiment 4

### Image Forming Apparatus

An electrophotographic image forming apparatus including the photoreceptor of the present invention will be hereinafter described.

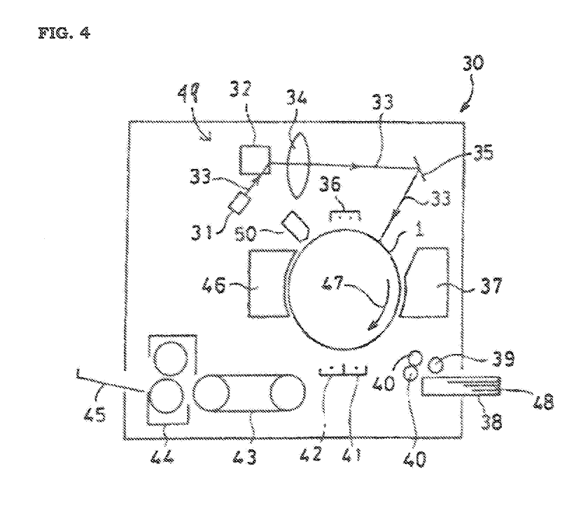

FIG. 4 is a schematic view (section view) showing the inside of an image forming apparatus 30 of the present Embodiment.

The image forming apparatus 30 is a laser printer. The image forming apparatus 30 includes the photoreceptor 1, a semiconductor laser 31, a rotary polygon mirror 32, an imaging lens 34, a mirror 35, a corona charger 36, a developing device 37, a transfer sheet cassette 38, a sheet feed roller 39, registration rollers 40, a transfer charger 41, a separation charger 42, a conveyance belt 43, a fixing device 44, a sheet discharge tray 45 and a cleaner 46.

The photoreceptor 1 is mounted in the image forming apparatus 30 in such a manner that it can be rotated in a direction of an arrow 47 by driving means, not shown. A laser beam 33 emitted from the semiconductor laser 31 is scanned by the rotary polygon mirror 32. The imaging lens 34 has an f-θ characteristic, and causes the laser beam 33 to be reflected on the mirror 35 to form an image on the surface of the photoreceptor 1. The laser beam 33 is scanned and imaged as described above while the photoreceptor 1 is rotated, thereby forming an electrostatic latent image according to image information on the surface of the photoreceptor 1.

The corona charger 36, the developing device 37, the transfer charger 41, the separation charger 42 and the cleaner 46 are disposed in this order from the upstream side to the downstream side in the rotation direction represented by the arrow 47 of the photoreceptor 1. The corona charger 36 is disposed on the upstream side of an imaging point of the laser beam 33 in the rotation direction of the photoreceptor 1 to uniformly charge the surface of the photoreceptor 1. Accordingly, the uniformly charged surface of the photoreceptor 1 is irradiated with the laser beam 33, generating a difference between the charge amount of an area irradiated with the laser beam 33 and the charge amount of an area not irradiated with the laser beam 33. Thus, the above-mentioned electrostatic latent image is formed.

The developing device 37 is disposed on the downstream side of the imaging point of the laser beam 33 in the rotation direction of the photoreceptor 1 and supplies a toner to the electrostatic latent image formed on the surface of the photoreceptor 1 to develop the electrostatic latent image into a toner image. Transfer sheets 48 contained in the transfer sheet cassette 38 are taken out one by one by the sheet feed roller 39 and provided to the transfer charger 41 by the registration rollers 40. The separation charger 42 removes charges from the transfer sheet to which the toner image has been transferred to separate the sheet from the photoreceptor 1.

The transfer sheet 48 separated from the photoreceptor 1 is conveyed to the fixing device 44 by the conveyance belt 43, and the toner image is fixed on the transfer sheet 48 by the fixing device 44. The transfer paper 48 on which an image has been thus formed is discharged to the sheet discharge tray 45. After the transfer sheet 48 is separated by the separation charger 42, the photoreceptor 1 keeps on rotating, while toner and foreign substances such as paper particles left on the surface of the photoreceptor 1 are cleaned by the cleaner 46. The charges of the parts of the photoreceptor 1 the surface of which has been cleaned are removed by a discharger (discharge lamp) 50. A series of image formation operations is repeated by rotation of the photoreceptor 1.

The image forming apparatus 30 is not limited to the configuration of the image forming apparatus shown in FIG. 4, and may be any of monochrome printers and color printers as long as they can include the photoreceptor. The image forming apparatus 30 can be various types of printers, copying machines, facsimile machines and multifunctional systems that use an electrophotographic process.

### EXAMPLES

Hereinafter, the present invention will be further described by the following examples which are illustrative only and do not limit the present invention.

### Example 1A

### Preparation of Undercoat Layer (Interlayer)

Titanium oxide (3 parts by weight, trade name: TIPAQUE TTO-D-1, available from Ishihara Sangyo Kaisha, Ltd.) and 2 parts by weight of a commercial polyamide resin (trade name: Amilan CM8000, available from Toray Industries, Inc.) were mixed with 25 parts by weight of methyl alcohol and the mixture was subjected to dispersion process in a paint shaker for 8 hours to give 3 kg of a coating solution for undercoat layer formation (the coating solution was the mixture obtained after the dispersion process). The coating solution was applied to a conductive support by a dip coating method. Specifically, a drum-like aluminum support having a diameter of 30 mm and a length of 357 mm as the conductive support was dipped in a coating vessel filled with the coating solution obtained, and then raised to form an undercoat layer (interlayer) having a film thickness of 1 μm.

### Preparation of Charge Generation Layer

A charge generation material used was an oxotitanylphthalocyanine showing a maximum diffraction peak at a Bragg angle (2θ±0.2°) of 27.3° and diffraction peaks at 7.3°, 9.4°, 9.7° and 27.3° in an X-ray diffraction spectrum as observed with the CuKα characteristic X-ray having a wavelength of 1.541 \acute{Å} and a binder resin used was a butyral resin (trade name: S-LEC BM-2, available from Sekisui Chemical Co., Ltd.). The charge generation material (1 part by weight) and 1 part by weight of the binder resin were mixed with 98 parts by weight of methyl ethyl ketone and the mixture was subjected to dispersion process with a paint shaker for 8 hours to give 3 liters of a coating solution for charge generation layer formation (the coating solution was the mixture obtained after the dispersion process). The coating solution for charge generation layer formation was then applied to a surface of the undercoat layer by a dip coating method in the same manner as in the undercoat layer formation. Specifically, the drum-like support with the previously-formed undercoat layer was dipped in a coating vessel filled with the coating solution for charge generation layer formation obtained, raised and air-dried to form a charge generation layer having a film thickness of 0.3 μm.

### Preparation of Charge Transport Layer

To 6 parts by weight of polytetrafluoroethylene resin fine particles (Lubron L2, available from Daikin Industries, Ltd.) having an average primary particle diameter of about 0.2 μm was added 0.12 parts by weight of GF-400 (available from Toagosei Co., Ltd.) as a particle dispersant, and 52.25 parts by weight of TS2050 (available from Teijin Chemicals, Ltd.) as a binder resin for forming a charge transport layer, 2.75 parts by weight of a low-surface-free-energy (γ) polycarbonate (a copolymer having a polycarbonate skeleton and a polydimethylsiloxane skeleton, viscosity average molecular weight (Mv): about 50,000) and 35 parts by weight of a compound (1) (T2269, available from Tokyo Chemical Industry Co., Ltd., N,N,N′,N′,-tetrakis(4-methylphenyl)benzidine) represented by the following formula:

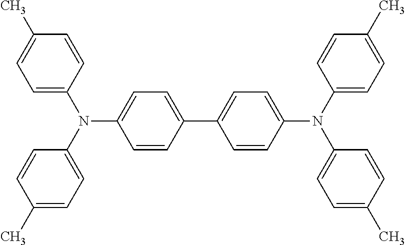 [SMILES: Cc1ccc(N(c2ccc(C)cc2)c2ccc(-c3ccc(N(c4ccc(C)cc4)c4ccc(C)cc4)cc3)cc2)cc1]

as a charge transport material were used.

The above components were mixed in tetrahydrofuran as a solvent to prepare a suspension having a solid content of 21% by weight. Thereafter, the suspension was passed through a wet emulsifying and dispersing machine (NVL-AS160: available from Yoshida Kikai Co., Ltd.) five times at a pressure set at 100 MPa to give 3 kg of a coating solution for forming a charge transport layer (the coating solution was the one obtained after dispersion process).

The coating solution for forming the charge transport layer was then applied on a surface of the charge generation layer by a dip coating method. Specifically, the drum-like support with the previously-formed charge generation layer was dipped in a coating vessel filled with the coating solution for forming the charge transport layer obtained, raised and dried at 120° C. for 1 hour to give a charge transport layer having a film thickness of 28 μm. Thus, the photoreceptor shown in FIG. 1 was prepared.

A photosensitive layer was prepared in the same manner as above except that the tetrafluoroethylene resin fine particles and the dispersant were omitted from the formulation of the charge transport layer. The resulting photoreceptor was measured for the surface free energy (γ value) of the outermost surface layer thereof, which was found to be 34.8 mJ/mm².

The proportion of primary particles and secondary particles having a particle diameter of less than 1 μm was 76% of the total fine resin particles. The coating solution containing dispersed fine particles immediately before application contained particles of 3 μm or more at a content of 4%.

### Example 2A

An undercoat layer and a charge generation layer were prepared in the same manner as in Example 1A. Thereafter, a coating solution for forming a charge transport layer was prepared in the same manner as in Example 1A except that 8 parts by weight of the tetrafluoroethylene resin fine particles and 0.16 parts by weight of GF-400 (available from Toagosei Co., Ltd.) as a particle dispersant were added, and then the coating solution was used for preparation of a photoreceptor.

The proportion of primary particles and secondary particles having a particle diameter of less than 1 μm was 76% of the total fine resin particles. The coating solution containing dispersed fine particles immediately before application contained particles of 3 μm or more at a content of 3.8%.

### Example 3A

An undercoat layer and a charge generation layer were prepared in the same manner as in Example 1A. Thereafter, a coating solution for forming a charge transport layer was prepared in the same manner as in Example 1A except that 10 parts by weight of the tetrafluoroethylene resin fine particles and 0.2 parts by weight of GF-400 (available from Toagosei Co., Ltd.) as a particle dispersant were added, and then the coating solution was used for preparation of a photoreceptor.

The proportion of primary particles and secondary particles having a particle diameter of less than 1 μm was 76% of the total fine resin particles. The coating solution containing dispersed fine particles immediately before application contained particles of 3 μm or more at a content of 3.9%.

### Example 4A

An undercoat layer and a charge generation layer were prepared in the same manner as in Example 1A. Thereafter, a coating solution for forming a charge transport layer was prepared in the same manner as in Example 1A except that 12 parts by weight of the tetrafluoroethylene resin fine particles and 0.24 parts by weight of GF-400 (available from Toagosei Co., Ltd.) as a particle dispersant were added, and then the coating solution was used for preparation of a photoreceptor.

The proportion of primary particles and secondary particles having a particle diameter of less than 1 μm was 76% of the total fine resin particles. The coating solution containing dispersed fine particles immediately before application contained particles of 3 μm or more at a content of 4.0%.

### Example 5A

An undercoat layer and a charge generation layer were prepared in the same manner as in Example 1A. Thereafter, a coating solution for forming a charge transport layer was prepared in the same manner as in Example 1A except that 14 parts by weight of the tetrafluoroethylene resin fine particles and 0.28 parts by weight of GF-400 (available from Toagosei Co., Ltd.) as a particle dispersant were added, and then the coating solution was used for preparation of a photoreceptor.

The proportion of primary particles and secondary particles having a particle diameter of less than 1 μm was 73% of the total fine resin particles. The coating solution containing dispersed fine particles immediately before application contained particles of 3 μm or more at a content of 4.2%.

### Example 6A

An undercoat layer and a charge generation layer were prepared in the same manner as in Example 1A. Thereafter, a coating solution for forming a charge transport layer was prepared in the same manner as in Example 3A except that 49.5 parts by weight of TS2050 (available from Teijin Chemicals, Ltd.) as a binder resin for forming a charge transport layer and 5.5 parts by weight of the low-γ polycarbonate were added, and then the coating solution was used for preparation of a photoreceptor.

The proportion of primary particles and secondary particles having a particle diameter of less than 1 μm was 74% of the total fine resin particles. The coating solution containing dispersed fine particles immediately before application contained particles of 3 μm or more at a content of 0.6%.

### Example 7A

An undercoat layer and a charge generation layer were prepared in the same manner as in Example 1A. Thereafter, a coating solution for forming a charge transport layer was prepared in the same manner as in Example 3A except that 33 parts by weight of TS2050 (available from Teijin Chemicals, Ltd.) as a binder resin for forming a charge transport layer and 22 parts by weight of the low-γ polycarbonate were added, and then the coating solution was used for preparation of a photoreceptor.

The proportion of primary particles and secondary particles having a particle diameter of less than 1 μm was 73% of the total fine resin particles. The coating solution containing dispersed fine particles immediately before application contained particles of 3 μm or more at a content of 0.3%.

### Example 8A

An undercoat layer and a charge generation layer were prepared in the same manner as in Example 1A. Thereafter, a coating solution for forming a charge transport layer was prepared in the same manner as in Example 3A except that 16.5 parts by weight of TS2050 (available from Teijin Chemicals, Ltd.) as a binder resin for forming a charge transport layer and 38.5 parts by weight of the low-γ polycarbonate were added, and then the coating solution was used for preparation of a photoreceptor.

The proportion of primary particles and secondary particles having a particle diameter of less than 1 μm was 73% of the total fine resin particles. The coating solution containing dispersed fine particles immediately before application contained particles of 3 μm or more at a content of 0.3%.

### Example 9A

An undercoat layer was prepared in the same manner as in Example 1A followed by preparation of a charge generation layer in the same manner as in Example 1A except that an oxotitanylphthalocyanine used had a crystal form showing first and second intense peaks at a Bragg angle (2θ±0.2°) of 9.4° and 9.7° and diffraction peaks at least at 7.3°, 9.4°, 9.7° and 27.3° in an X-ray diffraction spectrum. Thereafter, a coating solution for forming a charge transport layer was prepared in the same manner as in Example 3A, and then the coating solution was used for preparation of a photoreceptor

The proportion of primary particles and secondary particles having a particle diameter of less than 1 μm was 76% of the total fine resin particles. The coating solution containing dispersed fine particles immediately before application contained particles of 3 μm or more at a content of 4%.

### Comparative Example 1A

An undercoat layer and a charge generation layer were prepared in the same manner as in Example 3A. Thereafter, a coating solution for forming a charge transport layer was prepared in tetrahydrofuran as a solvent without adding the tetrafluoroethylene resin fine particles and the dispersant, and then the coating solution was used for preparation of a photoreceptor.

### Comparative Example 2A

An undercoat layer and a charge generation layer were prepared in the same manner as in Example 1A. Thereafter, a coating solution for forming a charge transport layer was prepared in the same manner as in Example 1A except that 0.8 parts by weight of tetrafluoroethylene resin fine particles and 0.016 parts by weight of GF-400 (available from Toagosei Co., Ltd.) as a particle dispersant were added, and then the coating solution was used for preparation of a photoreceptor.

The proportion of primary particles and secondary particles having a particle diameter of less than 1 μm was 76% of the total fine resin particles. The coating solution containing dispersed fine particles immediately before application contained particles of 3 μm or more at a content of 3.8%.

### Comparative Example 3A

An undercoat layer and a charge generation layer were prepared in the same manner as in Example 1A. Thereafter, a coating solution for forming a charge transport layer was prepared in the same manner as in Example 1A except that 18 parts by weight of tetrafluoroethylene resin fine particles and 0.36 parts by weight of GF-400 (available from Toagosei Co., Ltd.) as a particle dispersant were added, and then the coating solution was used for preparation of a photoreceptor.

The proportion of primary particles and secondary particles having a particle diameter of less than 1 μm was 76% of the total fine resin particles. The coating solution containing dispersed fine particles immediately before application contained particles of 3 μm or more at a content of 4.5%.

### Comparative Example 4A

An undercoat layer and a charge generation layer were prepared in the same manner as in Example 1A. Thereafter, a coating solution for forming a charge transport layer was prepared in the same manner as in Example 3A except that 53.9 parts by weight of TS2050 (available from Teijin Chemicals, Ltd.) as a binder resin for forming a charge transport layer and 1.1 parts by weight of the low-γ polycarbonate were added, and then the coating solution was used for preparation of a photoreceptor.

The proportion of primary particles and secondary particles having a particle diameter of less than 1 μm was 83% of the total fine resin particles. The coating solution containing dispersed fine particles immediately before application contained particles of 3 μm or more at a content of 0.2%.

### Comparative Example 5A

An undercoat layer and a charge generation layer were prepared in the same manner as in Example 1A. Thereafter, a coating solution for forming a charge transport layer was prepared in the same manner as in Example 3A except that 11 parts by weight of TS2050 (available from Teijin Chemicals, Ltd.) as a binder resin for forming a charge transport layer and 44 parts by weight of the low-γ polycarbonate were added, and then the coating solution was used for preparation of a photoreceptor.

The proportion of primary particles and secondary particles having a particle diameter of less than 1 μm was 73% of the total fine resin particles. The coating solution containing dispersed fine particles immediately before application contained particles of 3 μm or more at a content of 0.3%.

### Comparative Example 6A

An undercoat layer and a charge generation layer were prepared in the same manner as in Example 1A. Thereafter, a coating solution for forming a charge transport layer was prepared in the same manner as in Example 3A except that 55 parts by weight of TS2050 (available from Teijin Chemicals, Ltd.) as a binder resin for forming a charge transport layer was added, and then the coating solution was used for preparation of a photoreceptor.

The proportion of primary particles and secondary particles having a particle diameter of less than 1 μm was 95% of the total fine resin particles. The coating solution containing dispersed fine particles immediately before application contained particles of 3 μm or more at a content of 0.2%.

### Comparative Example 7A

An undercoat layer and a charge generation layer were prepared in the same manner as in Example 1A. Thereafter, a coating solution for forming a charge transport layer was prepared in the same manner as in Example 3A with the same formulation ratio as in Comparative Example 6A except that dispersion was carried out by passing the suspension through the wet emulsifying and dispersing machine five times with a pressure set at 50 MPa, and then the coating solution was used for preparation of a photoreceptor.

The proportion of primary particles and secondary particles having a particle diameter of less than 1 μm was 73% of the total fine resin particles. The coating solution containing dispersed fine particles immediately before application contained particles of 3 μm or more at a content of 6.2%.

### Evaluations for Photoreceptors of Examples 1a to 9A and Comparative Examples 2A to 7A

Evaluation of Distribution of Primary Particles and Secondary Particles of Less than 1 μm in Coating Films

The term “primary particle” of tetrafluoroethylene resin fine particles refers to the smallest unit of a fine particle existing without destroying the molecular bond in the tetrafluoroethylene resin, and “secondary particle” refers to a particle formed of a plurality of primary particles aggregated. As used herein, the phrase “the total number of primary particles and secondary particles” denotes the sum of the number of the “primary particles” and the number of the “secondary particles”, while the number of the “primary particles” does not include the number of primary particles which form secondary particles.

The number of “primary particles” and the number of “secondary particles” are determined as described below: that is, an image of a surface layer of a photoreceptor is obtained with a microscope such as a TEM (transmission electron microscope). The number of “primary particles” and the number of “secondary particles” were then measured by visually counting the numbers of the particles observed in the image of the surface layer.

### Measurement of Surface Free Energy

The surface free energy of a photoreceptor was determined with a contact angle meter CA-X (available from Kyowa Interface Science Co., Ltd.) and an analysis software EG-11 (available from Kyowa Interface Science Co., Ltd.).

### Evaluation of Dispersion Stability

The coating solution for forming a charge transport layer used in each of Examples 1A to 9A and Comparative Examples 2A to 7A was evaluated for the stability of the dispersion state of tetrafluoroethylene resin particles with a laser diffraction particle sizer (Microtrack MT-3000II, available from Nikkiso Co., Ltd.).

Specifically, 40 ml of each coating solution was taken and moved to a sample tube (50 ml) immediately after completion of the dispersion, stored in a thermostatic chamber (20° C.) for 3 months and measured for the aggregated particle diameter (median diameter; D50) of aggregated particles.

The dispersion stability was evaluated as follows using the determined aggregated particle diameter (particle diameter after agitation):

VG: very good (aggregated particle diameter<0.8 μm)

G: good (0.8 μm≦aggregated particle diameter<1.5 μm)

NB: tolerable for practical use (1.5 μm≦aggregated particle diameter<4.0 μm).

B: not tolerable for practical use (4.0 μm≦aggregated particle diameter)

Evaluation of Film Loss Amount after Actual Copying

The photoreceptor obtained in each Examples 1A to 9A and Comparative Examples 1A to 7A was mounted in a test copying machine obtained by modifying a digital copying machine (trade name: MX-2600, available from Sharp Corporation), provided with a surface potentiometer (model 344, available from TREK JAPAN) for measuring the surface potential of the photoreceptor in the image formation step. A laser source having a wavelength of 780 nm was used as a light source for exposure of the photoreceptor.

For each photoreceptor drum, a change in the film thickness of a photoreceptor between before and after the actual copying of 100,000 sheets was measured with an eddy-current thickness meter (available from Fischer Instruments K.K.), the measured value was converted to a film loss amount per 100,000 revolutions of the photoreceptor, and the converted value was regarded as the film loss amount. The film loss was evaluated on the basis of the film loss amount per 100,000 revolutions as follows:

VG: very good (film loss amount<0.8 μm)

G: good (0.8 μm≦film loss amount<1.0 μm)

NB: not bad (1.0 μm≦film loss amount<2.0 μm)

B: not good (2.0 μm<film loss amount)

### Evaluation of Electric Properties

Electric properties (sensitivity) of each photoreceptor of Examples 1A to 9A and Comparative Examples 1A to 7A were evaluated as follows:

With the above-mentioned test copying machine obtained by modifying a digital copying machine (trade name: MX-2600, available from Sharp Corporation), each photoreceptor prepared in Examples 1A to 9A and Comparative Examples 1A to 7A was measured for the surface potential VL in an initial stage (before printing) and after continuous copying of 100,000 sheets under a normal temperature/normal humidity (N/N) environment. In the present embodiment, the N/N environment refers to 25° C. and 50% RH (relative humidity). The surface potential VL refers to the surface potential of a photoreceptor in the black region during exposure, that is, the surface potential of the photoreceptor in the developing section.

The initial surface potential VL was then subtracted from the surface potential VL after continuous copying of 100,000 sheets to calculate ΔVL for each of Examples 1A to 9A and Comparative Examples 1A to 7A. Electric properties of the photoreceptor were evaluated as follows:

VG: very good (0≦ΔVL<15)

G: good (15≦ΔVL<50)

NB: tolerable for practical use (50≦ΔVL<100)

B: not tolerable for practical use (100≦ΔVL)

### Overall Evaluation

The results of evaluations of dispersion stability, film loss amount after actual copying and electric properties were collectively evaluated according to the following evaluation criteria.

VG: very good (two or more of the above three evaluation items were evaluated to be VG and the other was G)

G: good (all three evaluation items were evaluated to be G, or two were VG and one was NB)

B: not tolerable for practical use (one or more of the three evaluation items were evaluated to be B)

TABLE 1

| | Surface free | | | | | | | | | | | |
|---|---|---|---|---|---|---|---|---|---|---|---|---|
| | energy of | | | | | Film loss | | | | | | |
| | photoreceptor | | | Median | | amount | | | VL after | | | |
| | surface layer | | PTFE | diameter | | after actual | | | 100 k- | | | |
| | without comprising | PTFE | concentration | D50 after | | copying | | Initial | sheet | | | Overall |
| | tetrafluoroethylene | (φ: | (solid | 3 months | Evalu- | (μm/100 k | Evalu- | VL | copying | | Evalu- | evalu- |
| | [mJ/mm²] | 0.2 μm) | matter ratio) | (μm) | ation | revolutions) | ation | (−V) | (−V) | ΔVL | ation | ation |
| Example 1A | 34.8 | Lubron L2 | 6.2% | 0.9 | G | 0.95 | G | 72 | 88 | 16 | G | G |
| Example 2A | 34.8 | Lubron L2 | 8.5% | 0.95 | G | 0.75 | VG | 73 | 90 | 17 | G | G |
| Example 3A | 34.8 | Lubron L2 | 10.0% | 0.97 | G | 0.67 | VG | 76 | 94 | 18 | G | G |
| Example 4A | 34.8 | Lubron L2 | 11.6% | 0.97 | G | 0.62 | VG | 76 | 94 | 18 | G | G |
| Example 5A | 34.8 | Lubron L2 | 13.5% | 0.98 | G | 0.58 | VG | 75 | 126 | 51 | NB | G |
| Example 6A | 31.5 | Lubron L2 | 10.0% | 0.71 | VG | 0.65 | VG | 73 | 98 | 25 | G | VG |
| Example 7A | 27.8 | Lubron L2 | 10.0% | 0.7 | VG | 0.74 | VG | 69 | 95 | 26 | G | VG |
| Example 8A | 25.9 | Lubron L2 | 10.0% | 0.8 | VG | 0.77 | VG | 72 | 136 | 64 | NB | G |
| Example 9A | 34.8 | Lubron L2 | 10.0% | 0.97 | G | 0.78 | VG | 65 | 78 | 13 | VG | VG |
| Comparative | 34.8 | — | | — | — | 2.03 | B | 65 | 86 | 21 | G | B |
| Example 1A | | | | | | | | | | | | |
| Comparative | 34.8 | Lubron L2 | 0.9% | 2.2 | NB | 2.1 | B | 69 | 88 | 19 | G | B |
| Example 2A | | | | | | | | | | | | |
| Comparative | 34.8 | Lubron L2 | 16.1% | 4.5 | B | 0.55 | VG | 79 | 192 | 113 | B | B |
| Example 3A | | | | | | | | | | | | |
| Comparative | 38 | Lubron L2 | 10.0% | 4.3 | B | 0.68 | VG | 68 | 90 | 22 | G | B |
| Example 4A | | | | | | | | | | | | |
| Comparative | 24.2 | Lubron L2 | 10.0% | 0.8 | VG | 1.5 | NB | 72 | 202 | 130 | B | B |
| Example 5A | | | | | | | | | | | | |
| Comparative | 41.6 | Lubron L2 | 10.0% | 5.1 | B | 0.7 | VG | 80 | 183 | 103 | B | B |
| Example 6A | | | | | | | | | | | | |
| Comparative | 41.6 | Lubron L2 | 10.0% | 7.6 | B | 0.68 | VG | 82 | 196 | 114 | B | B |
| Example 7A | | | | | | | | | | | | |

As described above, a coating solution for forming a charge transport layer having excellent stability as a coating solution can be provided by including, in an outermost surface layer including tetrafluoroethylene resin fine particles of a photoreceptor, a binder resin as a component of a photoreceptor, which exhibits a surface free energy of 35 mJ/mm² or less in an outermost surface layer of a photoreceptor devoid of tetrafluoroethylene resin fine particles, and tetrafluoroethylene resin fine particles which include aggregated particles having a particle diameter of less than 1 μm at a content of less than 80% of the total particles and secondary particles of 3 μm or more at a content of no more than 5%. Moreover, by using the coating solution, an electrophotographic photoreceptor and an image forming apparatus having stable electric properties can be provided.

Specifically, it is assumed that a binder resin for forming a charge transport layer having a molecular unit in a repeating structure that allows maintenance of low surface free energy can compensate dispersibility of tetrafluoroethylene resin fine particles in a dispersion system dispersed by means of a dispersant, resulting in ensuring high dispersion stability as a coating solution.

When a dispersion was prepared by applying excess dispersing force, aggregated secondary particles having relatively large particle sizes could be temporarily dispersed into small primary particles. However, it was observed that the dispersion state of such a dispersion was deteriorated over time.

To the contrary when a coating solution for forming a charge transport layer was prepared with a binder resin without comprising the molecular unit in a repeating structure that allows maintenance of low surface free energy, particles could be dispersed so as to have a particle diameter of less than 1 μm. However the coating solution could not maintain high dispersibility as a coating solution and had deteriorated coating solution performances. As a result, a photoreceptor prepared with the coating solution had deteriorated electric properties. When an increased amount of a dispersant was added in order to prevent the deterioration, the coating solution obtained could be stabilized as a dispersion. However it was found that an electrophotographic photoreceptor prepared with such a coating solution had significantly deteriorated electric properties due to an increased amount of the dispersant and was not tolerable for practical use.

Thus it was found that each component is required to be used within the range defined in the present invention.

### Example 1B

### Preparation of Undercoat Layer (Interlayer)

Titanium oxide (3 parts by weight, trade name: TIPAQUE TTO-D-1, available from Ishihara Sangyo Kaisha, Ltd.) and 2 parts by weight of a commercial polyamide resin (trade name: Amilan CM8000, available from Toray Industries, Inc.) were mixed with 25 parts by weight of methyl alcohol and the mixture was subjected to dispersion process in a paint shaker for 8 hours to give 3 kg of a coating solution for undercoat layer formation (the coating solution was the mixture obtained after the dispersion process). The coating solution was applied to a conductive support by a dip coating method. Specifically, a drum-like aluminum support having a diameter of 30 mm and a length of 357 mm as the conductive support was dipped in a coating vessel filled with the coating solution obtained, and then raised to form an undercoat layer (interlayer) having a film thickness of 1 μm.

### Preparation of Charge Generation Layer

A charge generation material used was an oxotitanylphthalocyanine showing a first and second intense peaks at a Bragg angle (2θ±0.2°) of 9.4° and 9.7° and diffraction peaks at least at 7.3°, 9.4°, 9.7° and 27.3° in an X-ray diffraction spectrum as observed with the CuKα characteristic X-ray having a wavelength of 1.541 \acute{Å} and a binder resin used was a butyral resin (trade name: S-LEC BM-2, available from Sekisui Chemical Co., Ltd.). The charge generation material (1 part by weight) and 1 part by weight of the binder resin were mixed with 98 parts by weight of methyl ethyl ketone and the mixture was subjected to dispersion process with a paint shaker for 8 hours to give 3 liters of a coating solution for charge generation layer formation (the coating solution was the mixture obtained after the dispersion process). The coating solution for charge generation layer formation was then applied to a surface of the undercoat layer by a dip coating method in the same manner as in the undercoat layer formation. Specifically, the drum-like support with the previously-formed undercoat layer was dipped in a coating vessel filled with the coating solution for charge generation layer formation obtained, raised and air-dried to form a charge generation layer having a film thickness of 0.3 μm.

### Preparation of Charge Transport Layer

To 6 parts by weight of polytetrafluoroethylene resin fine particles (Lubron L2, available from Daikin Industries, Ltd.) having an average primary particle diameter of about 0.2 μm was added 0.12 parts by weight of GF-400 (available from Toagosei Co., Ltd.) as a particle dispersant, and 55 parts by weight of TS2050 (available from Teijin Chemicals, Ltd.) as a binder resin for forming a charge transport layer and 35 parts by weight of a compound (1) (T2269, available from Tokyo Chemical Industry Co., Ltd., N,N,N′,N′,-tetrakis(4-methylphenyl)benzidine) represented by the following formula:

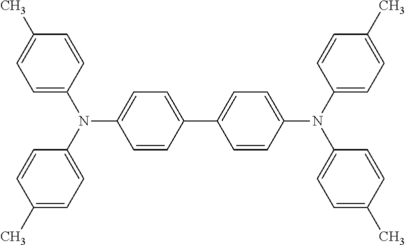 [SMILES: Cc1ccc(N(c2ccc(C)cc2)c2ccc(-c3ccc(N(c4ccc(C)cc4)c4ccc(C)cc4)cc3)cc2)cc1]

as a charge transport material were used.

The above components were mixed in tetrahydrofuran as a solvent to prepare a suspension having a solid content of 21% by weight. Thereafter, the suspension was passed through a wet emulsifying and dispersing machine (NVL-AS160: available from Yoshida Kikai Co., Ltd.) five times at a pressure set at 100 MPa to give 3 kg of a coating solution for forming a charge transport layer (the coating solution was the one obtained after the dispersion process).

The coating solution for forming the charge transport layer was then applied on a surface of the charge generation layer by a dip coating method. Specifically, the drum-like support with the previously-formed charge generation layer was dipped in a coating vessel filled with the coating solution for forming the charge transport layer obtained, raised and dried at 120° C. for 1 hour to give a charge transport layer having a film thickness of 28 μm. Thus, the photoreceptor shown in FIG. 1 was prepared.

A photosensitive layer was prepared in the same manner as above except that the tetrafluoroethylene resin fine particles and the dispersant were omitted from the formulation of the charge transport layer. The resulting photoreceptor was measured for the surface free energy (γ value) of the outermost surface layer thereof, which was found to be 41.6 mJ/mm².

### Example 2B

An undercoat layer and a charge generation layer were prepared in the same manner as in Example 1B. Thereafter, a coating solution for forming a charge transport layer was prepared in the same manner as in Example 1B except that 8 parts by weight of the tetrafluoroethylene resin fine particles and 0.16 parts by weight of GF-400 (available from Toagosei Co., Ltd.) as a particle dispersant were added, and then the coating solution was used for preparation of a photoreceptor.

### Example 3B

An undercoat layer and a charge generation layer were prepared in the same manner as in Example 1B. Thereafter, a coating solution for forming a charge transport layer was prepared in the same manner as in Example 1B except that 10 parts by weight of the tetrafluoroethylene resin fine particles and 0.2 parts by weight of GF-400 (available from Toagosei Co., Ltd.) as a particle dispersant were added, and then the coating solution was used for preparation of a photoreceptor.

### Example 4B

An undercoat layer and a charge generation layer were prepared in the same manner as in Example 3B. Thereafter, a coating solution was prepared in the same manner as in Example 3B except that the fine particles for forming a charge transport layer used were perfluoroalkoxyethylene (PFA) particles (average primary particle diameter: 2 μm, MP101, available from Du Pont-Mitsui Fluorochemicals Co., Ltd.) instead of tetrafluoroethylene particles, and then a photoreceptor was prepared.

### Example 5B

An undercoat layer and a charge generation layer were prepared in the same manner as in Example 1B. Thereafter, a coating solution for forming a charge transport layer was prepared in the same manner as in Example 1B except that 12 parts by weight of the tetrafluoroethylene resin fine particles and 0.24 parts by weight of GF-400 (available from Toagosei Co., Ltd.) as a particle dispersant were added, and then the coating solution was used for preparation of a photoreceptor.

### Example 6B

An undercoat layer and a charge generation layer were prepared in the same manner as in Example 1B. Thereafter, a coating solution for forming a charge transport layer was prepared in the same manner as in Example 1B except that 14 parts by weight of the tetrafluoroethylene resin fine particles and 0.28 parts by weight of GF-400 (available from Toagosei Co., Ltd.) as a particle dispersant were added, and then the coating solution was used for preparation of a photoreceptor.

### Example 7B

An undercoat layer and a charge generation layer were prepared in the same manner as in Example 1B. Thereafter, a coating solution for forming a charge transport layer was prepared in the same manner as in Example 3B except that 49.5 parts by weight of TS2050 (available from Teijin Chemicals, Ltd.) as a binder resin for forming a charge transport layer and 5.5 parts by weight of t a low-surface-free-energy (γ) polycarbonate (a copolymer having a polycarbonate skeleton and a polydimethylsiloxane skeleton, viscosity average molecular weight (Mv): about 50,000) were added, and then the coating solution was used for preparation of a photoreceptor.

A photosensitive layer was prepared in the same manner as above except that the tetrafluoroethylene resin fine particles and the dispersant were omitted from the formulation of the charge transport layer. The resulting photoreceptor was measured for the surface free energy (γ value) of the outermost surface layer thereof, which was found to be 31.5 mJ/mm².

### Example 8B

An undercoat layer and a charge generation layer were prepared in the same manner as in Example 1B. Thereafter, a coating solution for forming a charge transport layer was prepared in the same manner as in Example 3B except that 33 parts by weight of TS2050 (available from Teijin Chemicals, Ltd.) as a binder resin for forming a charge transport layer and 22 parts by weight of the low-γ polycarbonate were added, and then the coating solution was used for preparation of a photoreceptor.

A photosensitive layer was prepared in the same manner as above except that the tetrafluoroethylene resin fine particles and the dispersant were omitted from the formulation of the charge transport layer. The resulting photoreceptor was measured for the surface free energy (γ value) of the outermost surface layer thereof, which was found to be 28.2 mJ/mm².

### Example 9B

An undercoat layer and a charge generation layer were prepared in the same manner as in Example 1B. Thereafter, a coating solution for forming a charge transport layer was prepared in the same manner as in Example 3B except that 16.5 parts by weight of TS2050 (available from Teijin Chemicals, Ltd.) as a binder resin for forming a charge transport layer and 38.5 parts by weight of the low-γ polycarbonate were added, and then the coating solution was used for preparation of a photoreceptor.

A photosensitive layer was prepared in the same manner as above except that the tetrafluoroethylene resin fine particles and the dispersant were omitted from the formulation of the charge transport layer. The resulting photoreceptor was measured for the surface free energy (γ value) of the outermost surface layer thereof, which was found to be 25.9 mJ/mm².

### Comparative Example 1B

An undercoat layer and a charge generation layer were prepared in the same manner as in Example 1B. Thereafter, a coating solution for forming a charge transport layer was prepared in tetrahydrofuran as a solvent without adding tetrafluoroethylene fine particles and the dispersant.

### Comparative Example 2B

A photoreceptor was prepared in the same manner as in Example 3B except that the material for forming a charge transport layer used was an oxotitanylphthalocyanine showing diffraction peaks at a Bragg angle (2θ±0.2°) of 7.3°, 9.4°, 9.7° and 27.2°, the peak at 27.2° being maximum, in an X-ray diffraction spectrum as observed with the CuKα characteristic X-ray having a wavelength of 1.541 \acute{Å}.

### Comparative Example 3B

A photoreceptor was prepared in the same manner as in Example 3B except that the material for forming a charge transport layer used was an oxotitanylphthalocyanine showing diffraction peaks at a Bragg angle (2θ±0.2°) of 7.5°, 12.3°, 16.3°, 25.3° and 28.7°, the peak at 28.7° being maximum, in an X-ray diffraction spectrum as observed with the CuKα characteristic X-ray having a wavelength of 1.541 \acute{Å}.

### Evaluations for Photoreceptors of Examples 1B to 9B and Comparative Examples 1B to 3B

### Measurement of Surface Free Energy

The surface free energy of the photoreceptor without comprising fluorinated fine particles obtained in each of Examples 1B to 9B and Comparative Examples 1B to 3B was measured on a contact angle meter available from Kyowa Interface Science Co., Ltd. Evaluation of film loss amount after actual copying

The photoreceptor obtained in each of Examples 1B to 9B and Comparative Examples 1B to 3B was mounted in a test copying machine obtained by modifying a digital copying machine (trade name: MX-2600, available from Sharp Corporation), provided with a surface potentiometer (model 344, available from TREK JAPAN) for measuring the surface potential of the photoreceptor in the image formation step. A laser source having a wavelength of 780 nm was used as a light source for exposure of the photoreceptor.

For each photoreceptor drum, a change in the film thickness of a photoreceptor after the actual copying of 100,000 (100 k) sheets (difference in the film thickness of a photoreceptor between before and after the actual copying of 100,000 sheets) was measured with an eddy-current thickness meter (available from Fischer Instruments K.K.), the measured value was converted to a film loss amount per 100,000 revolutions of the photoreceptor. The change was regarded as the film loss amount. The film loss was evaluated on the basis of the film loss amount per 100,000 revolutions of the photoreceptor as follows:

VG: very good (film loss amount<0.8 μm)

G: good (0.8 μm≦film loss amount<1.0 μm)

NB: not bad (1.0 μm≦film loss amount<2.0 μm)

B: not good (2.0 μm<film loss amount)

### Evaluation of Electric Properties

Electric properties (sensitivity) of each photoreceptor of Examples 1B to 9B and Comparative Examples 1B to 3B were evaluated as follows:

With the above-mentioned test copying machine obtained by modifying a digital copying machine (trade name: MX-2600, available from Sharp Corporation), each photoreceptor prepared in Examples 1B to 9B and Comparative Examples 1B to 3B was measured for the surface potential VL in an initial stage (before printing) and after continuous copying of 100,000 sheets under a normal temperature/normal humidity (N/N) environment. In the present embodiment, the N/N environment refers to 25° C. and 50% RH (relative humidity). The surface potential VL refers to the surface potential of a photoreceptor in the black region during exposure, that is, the surface potential of the photoreceptor in the developing section.

The initial surface potential VL was then subtracted from the surface potential VL after continuous copying of 100,000 sheets to calculate ΔVL for each of Examples 1B to 9B and Comparative Examples 1B to 3B. Electric properties of the photoreceptor were evaluated as follows:

VG: very good (0≦ΔVL<50)

G: good (50≦ΔVL<100)

NB: tolerable for practical use (100≦ΔVL<150)

B: not tolerable for practical use (150≦ΔVL)

Evaluation of Image after Actual Copying of 100 k Sheets

Each photoreceptor of Examples 1B to 9B and Comparative Examples 1B to 3B was evaluated for image after actual copying of 100,000 sheets. The evaluation is hereinafter described.

After the actual copying under the N/N environment described above, each photoreceptor was used for printing of a full black image and a full white image and the extent of generation of image defects was evaluated.

VG: good density level without black or white dots

G: no problem; a few black or white dots

NB: tolerable for practical use; low density variation, although black and white dots were generated

B: not tolerable for practical use; many black and white dots or high density variation

### Overall Evaluation

The results of evaluations of film loss amount after actual copying, electric properties and images were collectively evaluated according to the following evaluation criteria.

VG: very good (two or more of the above three evaluation items were evaluated to be VG and the other was G)

G: good (all three evaluation items were evaluated to be G, or two were G and one was NB)

NB: tolerable for practical use (one of the above three evaluation items was G and the others were NB)

B: not tolerable for practical use (one or more of the three evaluation items were evaluated to be B)

TABLE 2

| | | | | | | | | | | | Evalu- | |
|---|---|---|---|---|---|---|---|---|---|---|---|---|
| | CGM^{a)} | | | | Film loss | | | | | | ation | |
| | position of | Surface free | | | amount | | | VL after | | | of image | |
| | maximum | energy of | | PTFE | after actual | | | 100 k- | | | after | |
| | diffraction | photoreceptor | PTFE | concentration | copying | | Initial | sheet | | | 100 k- | Overall |
| | peak(s): | surface layer^{b)} | (φ: | (solid | (μm/100 k | Evalu- | VL | copying | | Evalu- | sheet | evalu- |
| | 2θ | [mJ/mm²] | 0.2 μm) | matter ratio) | revolutions) | ation | (−V) | (−V) | ΔVL | ation | copying | ation |
| Example 1B | 9.4°/9.7° | 41.6 | Lubron L2 | 6.2% | 0.97 | G | 85 | 160 | 75 | G | G | G |
| Example 2B | 9.4°/9.7° | 41.6 | Lubron L2 | 8.5% | 0.84 | G | 88 | 172 | 84 | G | NB | G |
| Example 3B | 9.4°/9.7° | 41.6 | Lubron L2 | 10.00% | 0.69 | VG | 90 | 179 | 89 | G | NB | G |
| Example 4B | 9.4°/9.7° | 41.6 | PFA MP101 | 10.00% | 0.98 | G | 82 | 191 | 109 | NB | NB | NB |
| | | | [symbol] | | | | | | | | | |
| Example 5B | 9.4°/9.7° | 41.6 | Lubron L2 | 11.10% | 0.63 | VG | 92 | 178 | 86 | G | NB | G |
| Example 6B | 9.4°/9.7° | 41.6 | Lubron L2 | 13.58% | 0.59 | VG | 95 | 183 | 88 | G | NB | G |
| Example 7B | 9.4°/9.7° | 31.5 | Lubron L2 | 10.00% | 0.65 | VG | 73 | 121 | 48 | VG | VG | VG |
| Example 8B | 9.4°/9.7° | 28.2 | Lubron L2 | 10.00% | 0.74 | VG | 69 | 110 | 41 | VG | VG | VG |
| Example 9B | 9.4°/9.7° | 25.9 | Lubron L2 | 10.00% | 0.77 | VG | 66 | 106 | 40 | VG | VG | VG |
| Comparative | 94°/9.7° | 41.6 | — | — | 2.55 | B | 66 | 142 | 76 | G | G | B |
| Example 1B | | | | | | | | | | | | |
| Comparative | 27.2° | 41.6 | Lubron L2 | 10.00% | 0.72 | VG | 80 | 241 | 161 | B | B | B |
| Example 2B | | | | | | | | | | | | |
| Comparative | 25.3° | 41.6 | Lubron L2 | 10.00% | 0.75 | VG | 100 | 289 | 189 | B | B | B |
| Example 3B | | | | | | | | | | | | |

^{a)}CGM denotes a charge generation material, titanyl phthalocyanine
^{b)}Surface free energy of a photoreceptor without comprising tetrafluoroethylene resin fine particles [symbol]
indicates data missing or illegible when filed

As described above, it was found that, when fluorinated fine particles were included in an outermost surface layer of a photoreceptor and an oxotitanylphthalocyanine having a specific crystal form was used as a charge generation material, preferable electric properties were exhibited and improved wear resistance due to addition of the fluorinated fine particles and stable electric properties due to the charge generation layer could be obtained, and a photoreceptor having extended life could be obtained.

In a charge generation layer, oxotitanylphthalocyanine molecules are arranged so that the planar molecules are stacked. In a diffraction pattern, a peak at 9.4° corresponds to a distance between molecules on a plane and a peak at 27.2° corresponds to the stacking direction of the molecules. Although details have not been revealed, it is assumed that, because the oxotitanylphthalocyanine having an intense peak at 9.4° in fact shows preferable effects, the crystal grains having molecules preferentially arranged in a planar direction facilitate charge generation. Thus at an interface between a charge generation layer containing fluorinated fine particles and a charge transport layer, a charge generation material containing molecules aligned along a planar direction is more advantageous than a charge generation material containing molecules aligned in a stacking direction from a qualitative standpoint.

The present invention can provide a coating solution for forming a charge transport layer which can provide an electrophotographic photoreceptor without deterioration in electric properties even after long term use; an electrophotographic photoreceptor which can be prepared with the coating solution and can be used for electrophotographic image forming apparatuses such as printers, copying machines and facsimile machines; and an image forming apparatus.

1. A coating solution for forming a charge transport layer comprising a charge transport material, a binder resin and tetrafluoroethylene resin fine particles, wherein
the binder resin exhibits a surface free energy of 25 to 35 mJ/mm² in the charge transport layer formed with a coating solution for forming a charge transport layer without comprising the tetrafluoroethylene resin fine particles; and
the tetrafluoroethylene resin fine particles
(1) include primary particles having an average particle diameter of 0.1 to 0.5 μm and secondary particles corresponding to aggregates of the primary particles;
(2) account for 1 to 30% by weight of non-solvent components in the coating solution;
(3) contain primary particles and secondary particles having a particle diameter of less than 1 μm at a content of less than 80% by weight; and
(4) contain secondary particles having a particle diameter of 3 μm or more at a content of no more than 5% by weight.

2. The coating solution for forming the charge transport layer according to claim 1, wherein the tetrafluoroethylene resin fine particles contain primary particles having an average particle diameter of 0.2 to 0.4 μm.

3. The coating solution for forming the charge transport layer according to claim 1, wherein the tetrafluoroethylene resin fine particles account for 5 to 15% by weight of the non-solvent components in the coating solution.

4. The coating solution for forming the charge transport layer according to claim 1, wherein the tetrafluoroethylene resin fine particles account for 8 to 12% by weight of the non-solvent components in the coating solution.

5. The coating solution for forming the charge transport layer according to claim 1, wherein the surface free energy is in the range of 27 to 32 mJ/mm².

6. A multilayered electrophotographic photoreceptor having a charge generation layer containing at least a charge generation material and a charge transport layer containing a charge transport material stacked in this order on a conductive substrate, or a monolayer electrophotographic photoreceptor having a photosensitive layer containing a charge generation material and a charge transport material stacked on a conductive substrate, wherein an outermost surface layer of the photoreceptor contains at least the charge transport material, a binder resin and tetrafluoroethylene resin fine particles,
the binder resin exhibits a surface free energy of 25 to 35 mJ/mm² in the charge transport layer formed with a coating solution for forming a charge transport layer without comprising the tetrafluoroethylene resin fine particles; and
the tetrafluoroethylene resin fine particles
(1) include primary particles having an average particle diameter of 0.1 to 0.5 μm and secondary particles corresponding to aggregates of the primary particles;
(2) account for at 1 to 30% by weight of the outermost surface layer;
(3) contain primary particles and secondary particles having a particle diameter of less than 1 μm at a content of less than 80% by weight; and
(4) contain secondary particles having a particle diameter of 3 μm or more at a content of no more than 5% by weight.

7. A multilayered electrophotographic photoreceptor having a charge generation layer containing at least a charge generation material and a charge transport layer containing a charge transport material stacked in this order on a conductive substrate, or a monolayer electrophotographic photoreceptor having a photosensitive layer containing a charge generation material and a charge transport material stacked on a conductive substrate, wherein an outermost surface layer of the photoreceptor contains at least the charge transport material, a binder resin and tetrafluoroethylene resin fine particles,
the binder resin exhibits a surface free energy of 25 to 35 mJ/mm² in the charge transport layer formed with a coating solution for forming a charge transport layer without comprising the tetrafluoroethylene resin fine particles; and
the tetrafluoroethylene resin fine particles
(1) include primary particles having an average particle diameter of 0.1 to 0.5 μm and secondary particles corresponding to aggregates of the primary particles;
(2) account for at 1 to 30% by weight of the outermost surface layer;
(3) contain primary particles and secondary particles having a particle diameter of less than 1 μm at a content of less than 80% by weight; and
(4) contain secondary particles having a particle diameter of 3 μm or more at a content of no more than 5% by weight
wherein the outermost surface layer is formed with the coating solution for forming the charge transport layer according to claim 1.

8. The electrophotographic photoreceptor according to claim 6, wherein the charge generation material is a titanyl phthalocyanine having a crystal form showing, in an X-ray diffraction spectrum, a maximum diffraction peak at a Bragg angle (2θ±0.2°) of 27.3° and diffraction peaks at 7.3°, 9.4°, 9.7° and 27.3° or first and second intense peaks at 9.4° and 9.7° and diffraction peaks at least at 7.3°, 9.4°, 9.7° and 27.3°.

9. The electrophotographic photoreceptor according to claim 6, wherein the tetrafluoroethylene resin fine particles include primary particles having an average particle diameter of 0.2 to 0.4 μm.

10. The electrophotographic photoreceptor according to claim 6, wherein the tetrafluoroethylene resin fine particles account for 5 to 15% by weight of the outermost surface layer.

11. The electrophotographic photoreceptor according to claim 6, wherein the tetrafluoroethylene resin fine particles account for 8 to 12% by weight of the outermost surface layer.

12. The electrophotographic photoreceptor according to claim 6, wherein the surface free energy is in the range of 27 to 32 mJ/mm².

13. The electrophotographic photoreceptor according to claim 6, wherein the multilayered photosensitive layer is provided on the conductive substrate via an undercoat layer.

14. The electrophotographic photoreceptor according to claim 6, wherein the multilayered photosensitive layer includes two charge transport layers containing the charge transport material at different concentrations and the charge transport layer at the outermost surface layer contains the tetrafluoroethylene resin fine particles.

15. An image forming apparatus comprising: the electrophotographic photoreceptor according to claim 6; charge means for charging the electrophotographic photoreceptor; exposure means for exposing the charged electrophotographic photoreceptor to form an electrostatic latent image; developing means for developing the electrostatic latent image with toner to form a toner image; transfer means for transferring the toner image onto a recording material; and fixing means for fixing the transferred toner image on the recording material.
